(19) United States
(12) Patent Application Publication
(10) Pub. No.: US 2016/0117620 A1
(43) Pub. Date: Apr. 28, 2016

(54) METHODS AND SYSTEMS FOR VISUALIZING ITEMS

(71) Applicant: SCHLUMBERGER TECHNOLOGY CORPORATION, Sugar Land, TX (US)

(72) Inventors: Andrea Pound, Katy, TX (US); Varma Gottumukkala, Missouri City, TX (US)

(21) Appl. No.: 14/521,011

(22) Filed: Oct. 22, 2014

(51) Int. Cl. G06Q 10/06; G06F 3/0484; G06T 17/00; G06Q 50/02; G06T 3/60

(52) U.S. Cl. CPC G06Q 10/067; G06Q 50/02; G06T 3/60; G06T 17/00; G06F 3/04842

(57) ABSTRACT

Methods, computing systems, and computer-readable media for displaying information about an item such as a completion. An actual completion in a field includes multiple components. These components may include monitors that monitor various elements of the components (pressure, flow through the component, water cut, etc.) and generate real-time data for those elements. A computing system may display a three-dimensional model of the actual completion and display graphics representing the components. The graphics representing the components may be displayed on the three-dimensional model at locations corresponding to the actual locations of the components within the completion. The computing device may also receive real-time data for the actual components and display alerts on the display when the real-time data triggers alarm conditions.

### BACKGROUND

Visualizations of items, and alerts associated with those items, can be helpful in monitoring a particular item. For example, a completion in a hydrocarbon environment can be a valuable part of a system for producing hydrocarbons. A completion can also be complicated. For example, a completion may include multiple components situated at different locations within the completion, may have multiple laterals, or have other complicating aspects. In addition, a completion may be related to other completions for a particular field. The health of completions can matter for a hydrocarbon company and the ability to monitor the status of completions and quickly appreciate the nature of problems can be of great benefit to a hydrocarbon company.

### SUMMARY

Embodiments of the present disclosure may provide methods, computing systems, and computer-readable media for visualizing completions in a hydrocarbon environment. A system may include multiple actual components within an actual completion. These components may include monitors that monitor various elements of the components (pressure, flow through the component, water cut, etc.) and generate real-time data for those elements. The components may also include communications modules for sending the real-time data to a computing system. The computing system may include processors, a receiver for receiving the real-time data, and memory. The memory may include instructions for displaying a three-dimensional model of the actual completion and displaying graphics representing the components. The graphics representing the components may be displayed on the three-dimensional model at locations corresponding to the actual locations of the components within the completion. The computing device may also receive real-time data for the actual components and display alerts on the display when the real-time data triggers alarm conditions.

The disclosure may be realized as a non-transitory computer-readable medium that stores instructions that, when executed by a processor, causes the processor to perform operations. The operations may include displaying a three-dimensional model of an actual completion on a display and displaying a graphic representing an actual component of the completion on the three-dimensional model at a location that corresponds to the actual location of the component within the completion. The operations may also include receiving real-time data for the actual component and displaying an alert at the location of the graphic in response to the real-time data triggering one or more alarm conditions.

The disclosure may be realized as a method that involves displaying a three-dimensional model of an actual completion on a display and displaying a graphic representing an actual component of the completion on the three-dimensional model. The graphic may be displayed at a location that corresponds to the location of the actual component within the actual completion. The method may also involve receiving real-time data for the actual component and displaying an alert on the display if the real-time data triggers an alarm condition.

In other embodiments, the disclosure is realized in connection with an item that is not a completion. For example, the disclosure may be realized as a non-transitory computer-readable medium storing instructions for displaying a three-dimensional model of an actual item on a display and displaying a graphic representing an actual component of the item on the three-dimensional model. The graphic may be displayed at a location corresponding to the actual location of the component within the actual item. The media may also store instructions for receiving real-time data for the actual component and for displaying an alert at the location of the graphic representing the actual component if the real-time data triggers an alarm conditions.

The foregoing summary is provided to introduce a selection of concepts that are further described below in the detailed description. This summary is not intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for displaying a three-dimensional model of an item along with graphics representing the components of the item and alerts associated with the item.

FIG. 2 illustrates a conceptual, schematic view of a completion that includes various components.

FIG. 3 illustrates a conceptual, schematic view of a display screen showing a three-dimensional model of the completion.

FIG. 4 illustrates a conceptual, schematic view of a display screen showing a three-dimensional model of a completion and alerts associated with components of the completion.

FIG. 5 illustrates a conceptual, schematic view of a display screen showing additional information for a component of a completion.

FIG. 6 illustrates a conceptual, schematic view of a display screen showing a map of a field that includes multiple completions.

FIG. 7 illustrates a flowchart of a method for displaying a three-dimensional model of a completion along with graphics representing the components of the completion and alerts associated with the completion.

FIG. 8 illustrates a schematic view of a processor system.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

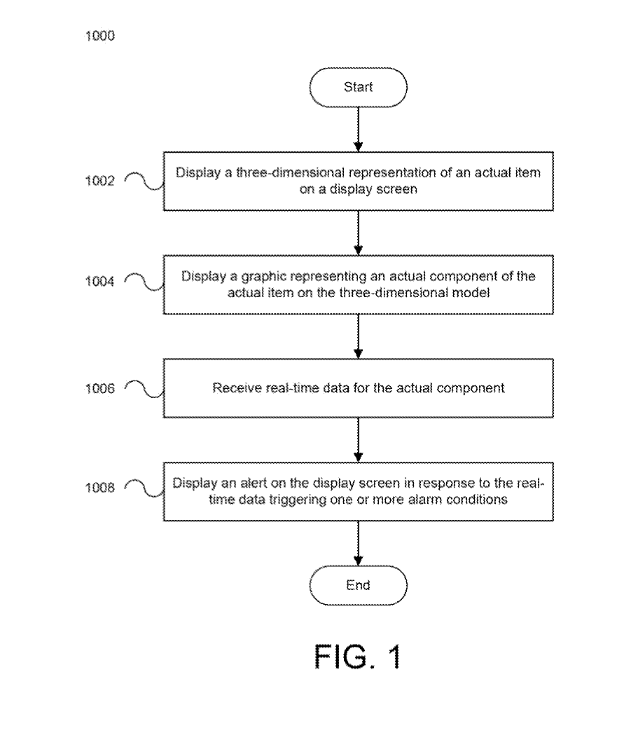

In general, embodiments of the present disclosure may provide systems, methods, and computer-readable media for generating and displaying three-dimensional models of actual item on a display. FIG. 1 displays an example of a method for displaying such a three-dimensional representation. The method 1000 may involve displaying 1002 a three-dimensional representation of an actual item on a display screen. For example, in one embodiment, the item may be an engine, such as an engine for a motor vehicle. The method 1000 may also involve displaying 1004 a graphic representing an actual component of the actual item on the three-dimensional model. For example, in one embodiment, the engine includes components such as pistons and cylinders which are represented graphically in the three-dimensional model. These graphics may be displayed on the three-dimensional model at the actual locations of the components within the actual item. Thus, the graphic representing the piston is situated within the three-dimensional model at the location where the actual piston is situated within the actual engine.

The method 1000 may also involve receiving real-time data for the actual components. The engine may include multiple components for which real-time data is gathered. One or more monitors may gather real-time data associated with the components of the engine, such as temperature, air/fuel mixture levels, and others. The method 1000 may further involve displaying 1008 an alert on the display screen in response to the real-time data triggering one or more alarm conditions. For example, in a three-dimensional model of an engine, if the heat of an engine component is outside a threshold, that engine component within the three-dimensional model may have its color changed from green to red to indicate the alert. The user may then select the engine component to gather more information about the alarm condition.

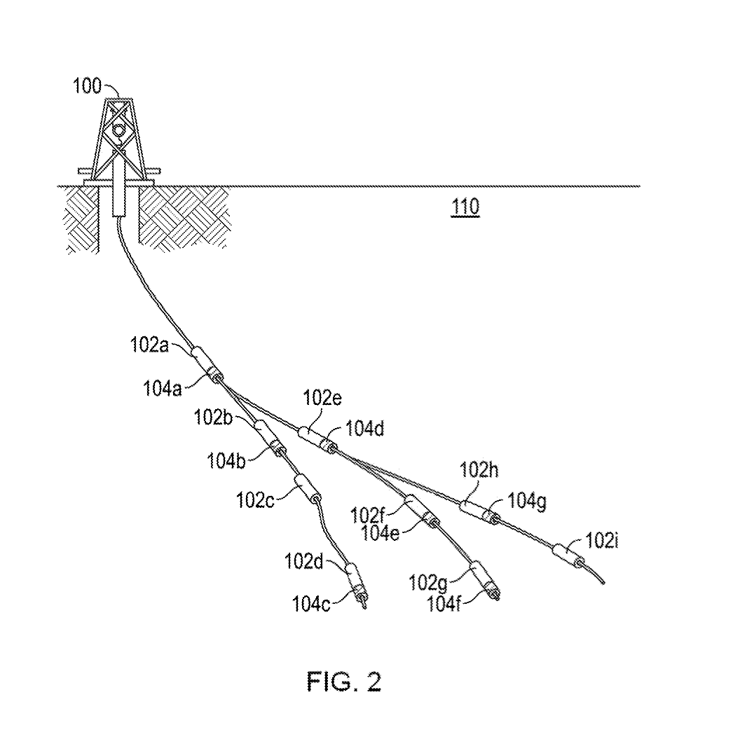

FIG. 2 illustrates an example of an environment in which such an approach may be used. FIG. 2 illustrates an example of an actual completion 100 below the surface 110. As used herein, an “actual completion” refers to the actual components and structures that enable production from a hydrocarbon well. As used herein, an “actual component” refers to physical equipment for an item such as an actual completion. The actual component may be a packer, a sensor, a tubular, a section of tubular, a meter, or other physical device. The type of physical equipment may vary from completion to completion. FIG. 2 illustrates an actual completion 100 that includes actual components 102a-102i. Different types of actual components 102 may play different roles in extracting hydrocarbons through the actual completion 100. The actual completion 100 shown in FIG. 2 may be one of multiple actual completions for a particular field. Through the actual completion 100, a company may extract hydrocarbons from the subsurface 110.

Actual components 102 may include monitors 104, such as the monitors 104a-g illustrated in FIG. 2. The monitors 104 monitor one or more elements at the actual component 102 and generate real-time data. A monitor 104 may be an integral component built into an actual component 102, or it may be separate from the actual component 102 but associated with the actual component 102 such that it generates real-time data for the actual component 102. A monitor 104 may, for example, monitor the pressure, temperature, rate, water cut, or other elements for the actual component 102. The monitor 104 may generate real-time data associated with that element. For example, the monitor 104c may monitor and measure the pressure at component 102d and send real-time data representing the measured pressure values.

The actual component 102 may also include a communications module for sending the real-time data generated by the monitors 104. The communications module may be part of the monitor 104 associated with the actual component 102. The communications module may send the real-time data using a wireless communications component, a wired communications component, or other suitable technology for communicating real-time data. In certain embodiments, the communications modules send the real-time data to a surface acquisition unit (not shown). The surface acquisition unit may store the real-time data received for multiple actual components 102 of the actual completion 100. The surface acquisition unit may be configured to share the real-time data with local or remote computing devices. In one embodiment, the surface acquisition unit sends the real-time data to a computing system that includes processors and memory. The computing system may include instructions for creating visualizations such as those discussed below.

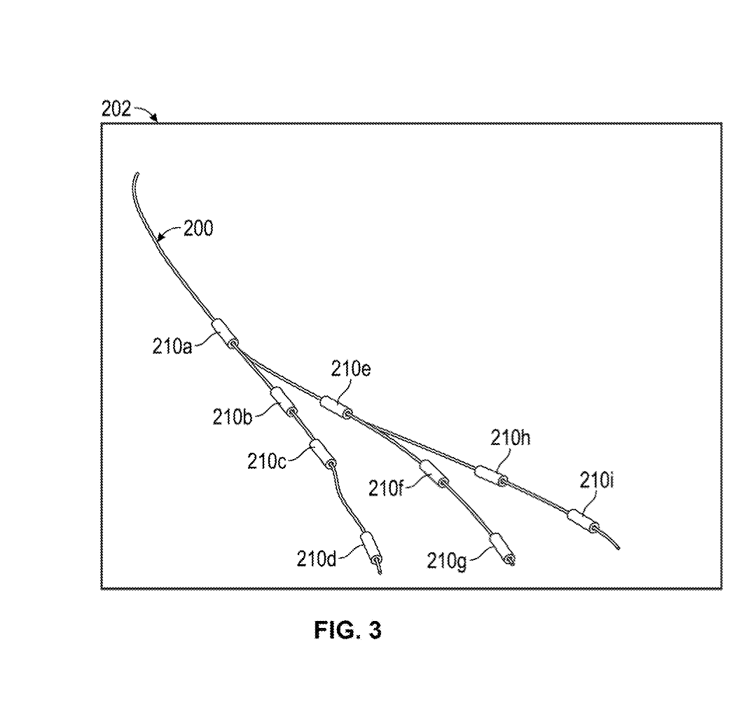

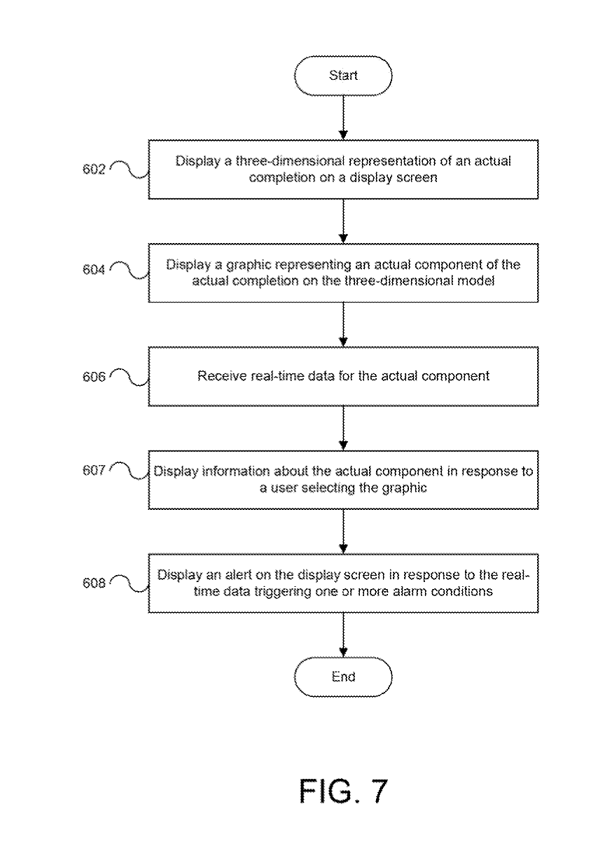

FIG. 3 illustrates one embodiment of a three-dimensional model 200 of the actual completion 100 displayed on a display 202. The display 202 may be a standard computer monitor, a television, mobile device screen, or other suitable display. The display 202 is connected to a computing system (such as that shown in FIG. 7) that includes a processor and memory.

The three-dimensional model 200 allows the user to see how the actual completion 100 is disposed. In certain embodiments, the three-dimensional model 200 may be rotatable within the three dimensions. For example, the user may be able to use a mouse to “spin” the three-dimensional model 200 in order to see it from a different perspective. The computing device may also include instructions allowing the user to zoom in and zoom out on the three-dimensional model 200. This may allow the user to look more closely at specific areas of interest.

Graphics 210 representing the actual components 104 are displayed on the three-dimensional model 200 at locations that correspond to the actual locations of the components 102 within the completion 100. The three-dimensional model 200 may thus allow the user to see where in the actual completion 100 the actual components 104 are located. In FIG. 3, the graphics 210a-i are shown at locations in the three-dimensional model 200 that correspond to the locations of the actual components 102a-i in the actual completion 100 shown in FIG. 3. The graphics 210, or information about them, may also be displayed at other locations on the display 202 as well; for example, the application may create a sidebar displayed on a side of the display 202 and include the graphics 210 in the sidebar as part of a list of actual components 104.

The graphics 210 representing the actual components 104 may have any suitable appearance. In one embodiment, graphics 210 of the same or similar components 104 have common characteristics. For example, flow meters may be represented as having a triangular shape. In another embodiment, packers are represented with the same color. Other ways in which components 104 may be represented graphically in the three-dimensional model 200 may also be used.

As described in greater detail below, alerts may also be displayed on the display screen 202 if actual components 104 experience problems or are in a state that may be of interest to the user. For example, if values of real-time data for a particular component fall outside of predefined bounds, the color of the graphic 210 representing the actual component 102 may change from green to red. These alerts may help the user appreciate what is happening within the actual completion 100 and what areas could use attention.

In certain embodiments, the three-dimensional model 200 is shown alongside data about the makeup of the subterranean environment. For example, the three-dimensional model 200 may be shown along with reservoir model data. The reservoir model data may provide information about the lithology and the fluid contacts in the reservoir. The reservoir model data may include geological information or other relevant data. Similarly, the three-dimensional model 200 may be shown along with well log information. Viewing the three-dimensional model 200 in the context of the reservoir model data may aid the user in appreciating any connection between the physical environment and alerts.

In one embodiment, the three-dimensional model 200 is created automatically from information about the actual completion 100. In one embodiment, the three-dimensional model 200 is created from the deviation survey data for the actual completion 100. Data about the placement of the actual components 104 (for example, recorded measured depth for the actual component 104, which lateral in a multi-lateral well, etc.) may be used to determine where to locate the graphics 210 representing the actual components 104 within the three-dimensional model 200.

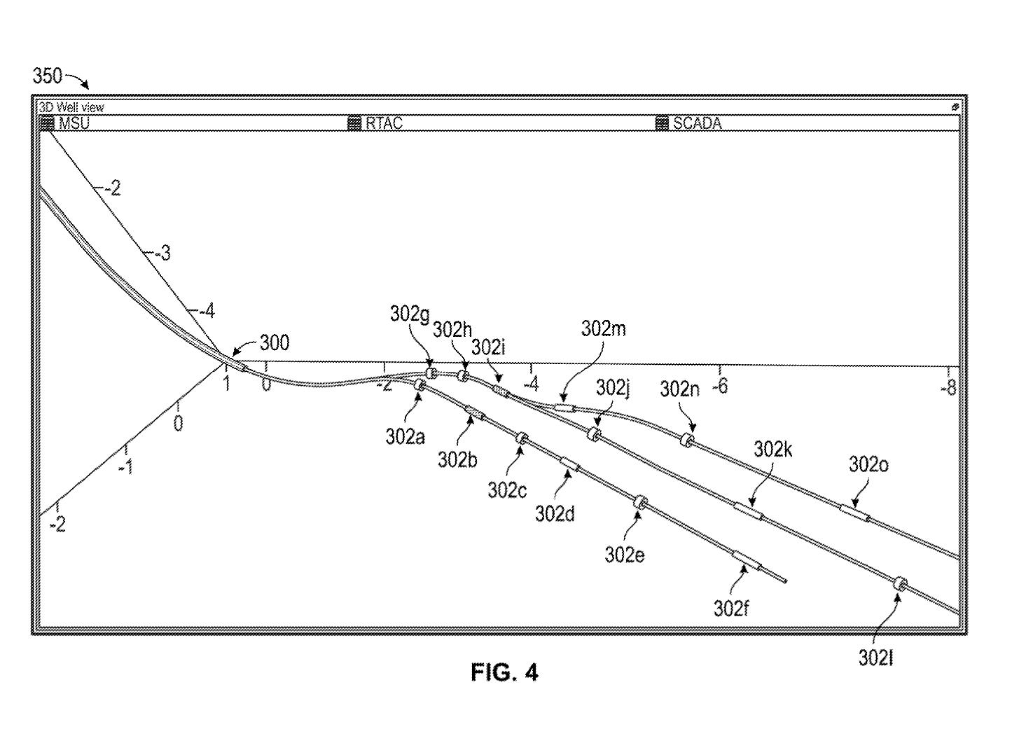

FIG. 4 shows another embodiment of a three-dimensional model, designated three-dimensional model 300. The three-dimensional model 300 shown in FIG. 4 includes the graphics 302a-o representing actual components 102. In certain embodiments, alerts are displayed on the display screen 350 in response to real-time data triggering one or more alarm conditions. In FIG. 4, the alerts are displayed at the location of the graphics 302b and 302i.

In certain embodiments, an alert may be defined by one or more rules associated with the real-time data. An alert may be generated when one or more data values fall outside a scope defined by the rules. The alert may be displayed by changing the color of the graphic 302. For example, the colors green, yellow, and red may be used to indicate that a particular actual component 102 is within limits, close to limits, or outside limits respectively. Other approaches to displaying an alert may also be used alone or in combination with the above. For example, the alert may involve automatically opening a dialog box on the display screen 350 when one or more alarm conditions for the alert are met. The alert may also include an audible component. The alert may also include a notification or message sent to another device via email, text message, or other appropriate approach to sending notifications.

The alarm conditions for the real-time data may be defined by a user, provided with default values, or a combination thereof. The alarm conditions may be one or more threshold values that define different alarm levels. For example, if a real-time data value falls outside a particular range, an alarm condition may be triggered. In certain embodiments, the alarm conditions are applied to averages of real-time data. For example, in one embodiment, average real-time data values over a 30 second period are compared to the threshold values.

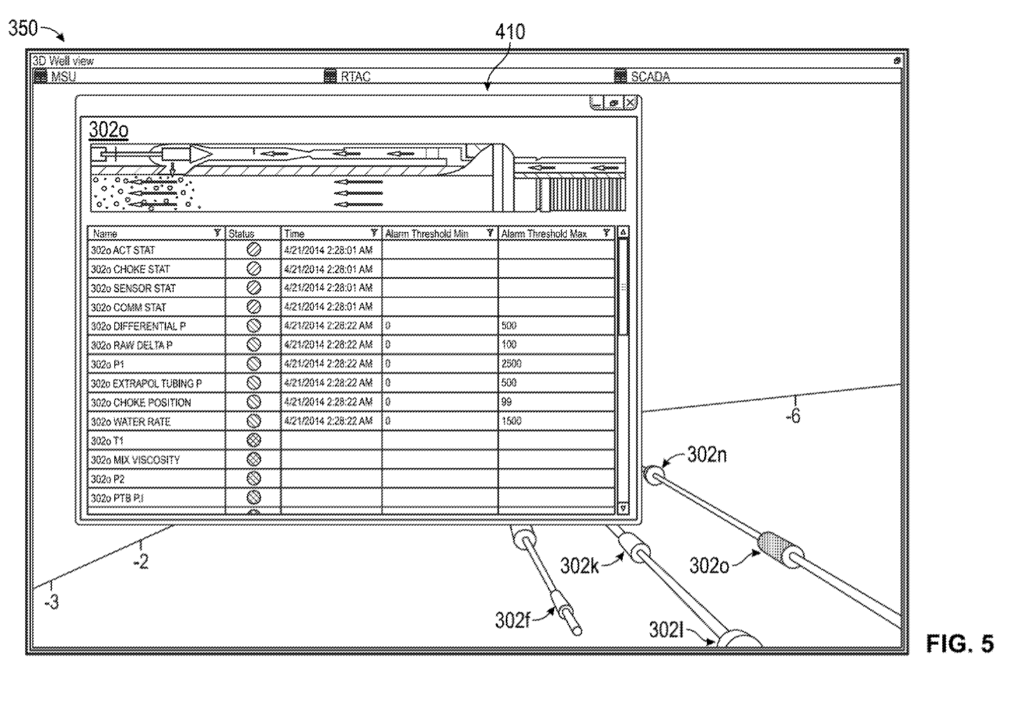

In certain embodiments, a user may desire additional information about a particular actual component 102. The user may select the graphic 302 to cause additional information about the actual component 102 to be displayed on the display 202. The user may select the graphic 302 by clicking on it with a mouse, selecting it from a list, or other appropriate selection actions. FIG. 5 illustrates one embodiment of a window 410 containing additional information for a graphic 302o being displayed on the display screen 350.

In the example shown in FIG. 5, a new window 410 is opened with the information for the component 102 associated with the graphic 302o. In other embodiments, the information may be presented in a side bar or other area of the display without opening a window 410. The user may thus select a particular graphic representation 302 to initiate investigation from a three-dimensional context. The window 410 may provide additional detail about what the actual component 102 is and the data that it is collecting.

The information may include an illustration of the actual component 102. The information may include an identifier that identifies the actual component 102 such as, for example, the name, type, or manufacturer of the actual component 102. The information may include real-time data collected for the actual component 102. In certain embodiments, the real-time data is shown as it is received in real time. The additional information may also include a historical view of the real-time data.

In certain embodiments, the actual component 102 may have multiple parameters that are measured at the actual component 102. The additional information may identify which parameters are measured and the current values for those parameters. For example, the actual component 102 represented by graphic 302a in FIG. 5 may have parameters such as “choke stat”, “differential p”, “choke position”, and others that are measured at the actual component 102. The information may include the status associated with the particular element and the time of measurement.

In embodiments where the graphic 302 includes multiple elements that are measured and reported for the actual component 102 represented by the graphic 302, the alert may be triggered if any of the alarm conditions for the elements measured for the actual component 102 are met. For example, if any of the multiple elements shown in FIG. 5 have values that trigger an alarm condition, the graphic 302o may change to red. The user may then request additional information by, for example, clicking on the graphic 302o in order to view the additional information and determine which element is associated with the alarm condition.

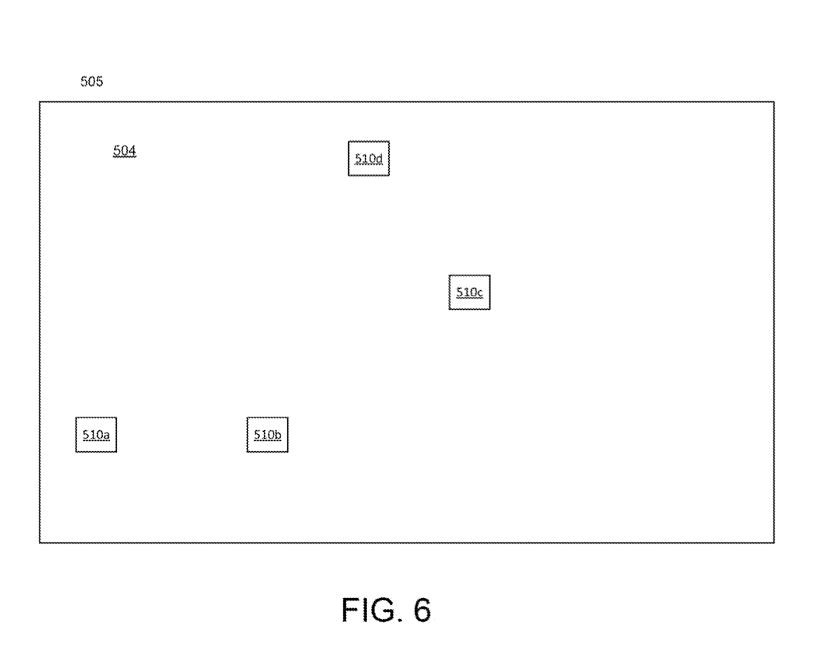

FIG. 6 illustrates one embodiment of a display screen 505 showing a map of a field 504 that includes multiple completion icons 510 labeled individually as 510a-d. Each completion icon 510 represents an actual completion 100 in a field (graphically represented as 504). In certain embodiments, an application provides a graphical representation of a field 504 and displays multiple completion icons 510 over a map of the field 504. The completion level view illustrated in FIG. 6 may allow a user to view information at a completion level and monitor multiple completions 100 at a time.

A single completion icon 510 may be associated with multiple possible alarm conditions for those components within the completion represented by the completion icon 510. In one embodiment, when an alarm condition occurs for a particular completion 100, an alert is displayed for the completion. For example, if an alarm condition occurs for an actual component 102 of a completion represented by completion icon 510c, an alert may be displayed on the display screen 505 for the completion icon 510c. In one embodiment, the color of the completion icon 510c changes in response to the alarm condition for the component within the completion represented by the completion icon 510c.

In certain embodiments, the field-completion-component structure may be hierarchal. For example, a field may contain many completions, and a completion may contain many components. The alarm conditions may be configured to account for the hierarchical structure. For example, an alarm condition for a component may affect the status of the component itself, the completion that includes the component, and the field that includes the completion. The manner in which the alert is displayed may vary depending on what level of the hierarchy is being viewed by the user.

For example, an alarm condition for a component in the completion represented by completion icon 510c may cause the color of the completion icon 510c to change. The user may select the completion icon 510c after seeing the alarm condition. A three-dimensional model of the completion 100 associated with the completion icon 510c may then be displayed, such as that shown in FIG. 4. In the three-dimensional model, the particular component associated with the alarm condition may be shown in red.

Alerts may be further “nested” in addition to the manner described above; for example, another view within the application may show multiple fields. When an alert is generated for one of the completions within the field, an icon for that particular field may change color. In response to the user selecting the field icon, the view shown in FIG. 6 may be displayed with an alert for the relevant completion icon associated with the alarm condition. The user may then select the completion icon to generate a view such as that in FIG. 4, and select a particular graphic representing an actual component to see the real time data.

FIG. 7 illustrates one embodiment of a method 600 for creating a three-dimensional representation of an actual completion. In one embodiment, the method begins with displaying 602 a three-dimensional representation of an actual completion on a display screen. The method 600 may further involve displaying 604 a graphic representing an actual component of the actual completion on the three-dimensional model at a location corresponding to the actual location of the component within the completion. In some embodiments, there are multiple actual components within the completion and additional graphics representing these additional components are displayed. This may allow the user to quickly appreciate the nature and structure of the completion, the types of components within it, and the location of those components.

The method 600 may also involve receiving 606 real-time data for the actual component shown in connection with the three-dimensional model of the completion. In certain embodiments, the method 600 may involve, in response to a user selecting the graphic representing the actual component, displaying 607 information about the actual component on the display screen. This information may include, for example, an identifier of the actual component, real-time data collected for the actual component, or other information.

The method 600 may include displaying 608 an alert on the display screen in response to the real-time data triggering one or more alarm conditions such as those described above. Displaying the alert, in one embodiment, involves changing the color of the graphic representing the actual component (for example, changing the color from green to red).

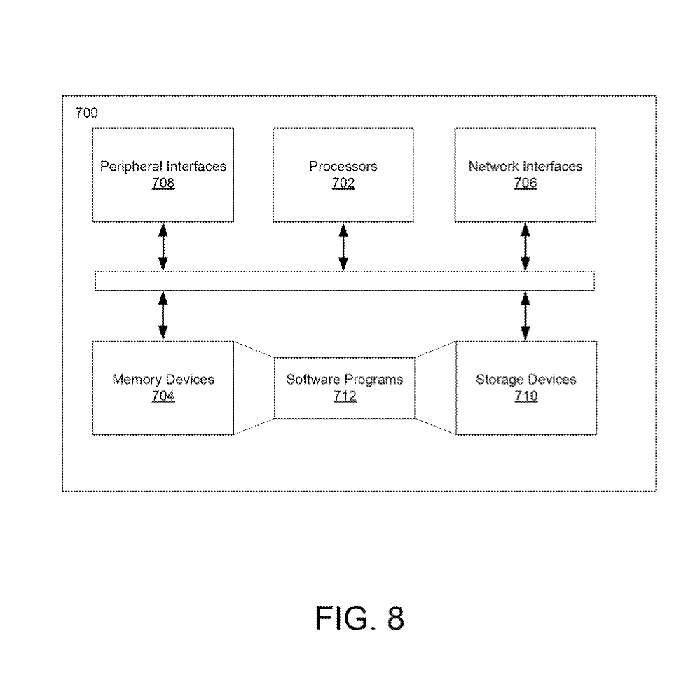

Embodiments of the disclosure may also include one or more systems for implementing one or more embodiments of the method 600. FIG. 8 illustrates a schematic view of such a computing or processor system 700, according to an embodiment. The processor system 700 may include one or more processors 702 of varying core configurations (including multiple cores) and clock frequencies. The one or more processors 702 may be operable to execute instructions, apply logic, etc. It will be appreciated that these functions may be provided by multiple processors or multiple cores on a single chip operating in parallel and/or communicably linked together. In at least one embodiment, the one or more processors 702 may be or include one or more GPUs.

The processor system 700 may also include a memory system, which may be or include one or more memory devices and/or computer-readable media 704 of varying physical dimensions, accessibility, storage capacities, etc. such as flash drives, hard drives, disks, random access memory, etc., for storing data, such as images, files, and program instructions for execution by the processor 702. In an embodiment, the computer-readable media 704 may store instructions that, when executed by the processor 702, are configured to cause the processor system 700 to perform operations. For example, execution of such instructions may cause the processor system 700 to implement one or more portions and/or embodiments of the method(s) described above.

The processor system 700 may also include one or more network interfaces 706. The network interfaces 706 may include any hardware, applications, and/or other software. Accordingly, the network interfaces 706 may include Ethernet adapters, wireless transceivers, PCI interfaces, and/or serial network components, for communicating over wired or wireless media using protocols, such as Ethernet, wireless Ethernet, etc.

As an example, the processor system 700 may be a mobile device that includes one or more network interfaces for communication of information. For example, a mobile device may include a wireless network interface (e.g., operable via one or more IEEE 802.11 protocols, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

The processor system 700 may further include one or more peripheral interfaces 708, for communication with a display, projector, keyboards, mice, touchpads, sensors, other types of input and/or output peripherals, and/or the like. In some implementations, the components of processor system 700 may not be enclosed within a single enclosure or even located in close proximity to one another, but in other implementations, the components and/or others may be provided in a single enclosure. As an example, a system may be a distributed environment, for example, a so-called “cloud” environment where various devices, components, etc. interact for purposes of data storage, communications, computing, etc. As an example, a method may be implemented in a distributed environment (e.g., wholly or in part as a cloud-based service).

As an example, information may be input from a display (e.g., a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

The memory device 704 may be physically or logically arranged or configured to store data on one or more storage devices 710. The storage device 710 may include one or more file systems or databases in any suitable format. The storage device 710 may also include one or more software programs 712, which may contain interpretable or executable instructions for performing one or more of the disclosed processes. When requested by the processor 702, one or more of the software programs 712, or a portion thereof, may be loaded from the storage devices 710 to the memory devices 704 for execution by the processor 702.

Those skilled in the art will appreciate that the above-described componentry is merely one example of a hardware configuration, as the processor system 700 may include any type of hardware components, including any accompanying firmware or software, for performing the disclosed implementations. The processor system 700 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 700 may be used to execute programs according to instructions received from another program or from another processor system altogether. Similarly, commands may be received, executed, and their output returned entirely within the processing and/or memory of the processor system 700. Accordingly, the described embodiments may be performed without a visual interface command terminal or other terminal.

Likewise, the method described may not be performed in the same sequence discussed or with the same degree of separation. Various aspects may be omitted, repeated, combined, or divided, as appropriate to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques. In the claims that follow, section 112 paragraph sixth is not invoked unless the phrase “means for” is used.

What is claimed is:

1. A method comprising:
displaying a three-dimensional model of an actual completion on a display;
displaying a graphic representing an actual component of the actual completion on the three-dimensional model at a location that corresponds to an actual location of the actual component within the actual completion;
receiving real-time data for the actual component; and
displaying an alert on the display in response to the real-time data triggering one or more alarm conditions.

2. The method of claim 1, wherein the actual component comprises a monitor that monitors one or more elements at the actual component and generates the real-time data.

3. The method of claim 1, wherein the three-dimensional model is rotatable within the three dimensions.

4. The method of claim 1, further comprising, in response to a user selecting the graphic representing the actual component, displaying information about the actual component on the display.

5. The method of claim 4, wherein the information about the actual component includes information selected from the group consisting of: an identifier for the actual component; and the real-time data collected for the actual component.

6. The method of claim 1, further comprising displaying one or more additional graphics representing one or more additional actual components.

7. The method of claim 1, wherein displaying the alert comprises changing a color of the graphic representing the actual component.

8. The method of claim 1, wherein the three-dimensional model is displayed in response to a user selecting an icon representing the actual completion within a field comprising a plurality of additional actual completions.

9. A non-transitory computer-readable medium storing instructions that, when executed by a processor, cause the processor to perform operations, the operations comprising:
displaying a three-dimensional model of an actual completion on a display;
displaying a graphic representing an actual component of the actual completion on the three-dimensional model at a location corresponding to an actual location of the actual component within the actual completion;
receiving real-time data for the actual component; and
displaying an alert at the location of the graphic representing the actual component in response to the real-time data triggering one or more alarm conditions.

10. The media of claim 9, wherein the three-dimensional model is rotatable within the three dimensions.

11. The media of claim 9, the operations further comprising, in response to a user selecting the graphic, displaying information about the actual component.

12. The media of claim 11, wherein the information about the actual component comprises:
an identifier for the actual component; and
real-time data collected for the actual component.

13. The media of claim 9, wherein the three-dimensional model is displayed in response to a user selecting an icon representing the actual completion within a field comprising a plurality of additional actual completions.

14. The media of claim 9, the operations further comprising:
receiving deviation survey information for the actual completion; and
creating the three-dimensional model using the deviation survey information.

15. A system, comprising:
an actual component of an actual completion, the actual component comprising:
one or more monitors that monitor one or more elements at the actual component and generates real-time data;
one or more communications modules for sending the real-time data to a computing system;
the computing system comprising:
one or more processors;
a receiver for receiving the real-time data; and
a memory system comprising one or more non-transitory computer-readable media comprising instructions that, when executed by at least one of the one or more processors, cause the computing system to perform operations, the operations comprising:
displaying a three-dimensional model of the actual completion on a display;
displaying a graphic representing the actual component of the actual completion on the three-dimensional model at a location corresponding to an actual location of the actual component within the actual completion; and
displaying an alert at the location of the graphic representing the actual component in response to the real-time data triggering one or more alarm conditions.

16. The system of claim 15, the operations further comprising:
receiving deviation survey information for the actual completion; and
creating the three-dimensional model using the deviation survey information.

17. The system of claim 15, wherein the three-dimensional model is rotatable within the three dimensions.

18. The system of claim 15, wherein displaying the alert comprises changing a color of the graphic representing the actual component.

19. The system of claim 15, wherein the computing system is communicatively connected to the actual component through a communications network.

20. A non-transitory computer-readable medium storing instructions that, when executed by a processor, cause the processor to perform operations, the operations comprising:
displaying a three-dimensional model of an actual item on a display;
displaying a plurality of graphics representing a plurality of actual components of the actual item on the three-dimensional model at locations corresponding to actual locations of the actual components within the actual item;
receiving real-time data for the actual components; and
displaying an alert at the locations of the graphic representing the actual component in response to the real-time data triggering one or more alarm conditions.
